(19) United States
(12) Patent Application Publication
(10) Pub. No.: US 2026/0058060 A1
(43) Pub. Date: Feb. 26, 2026

(54) DIELECTRIC POWDER COMPOSITION FOR MULTI-LAYERED CERAMIC CAPACITOR AND MANUFACTURING METHOD THEREOF

(71) Applicant: SAMHWA CAPACITOR CO., LTD., Yongin-si (KR)

(72) Inventors: Young Joo OH, Yongin-si (KR); Jung Rag YOON, Yongin-si (KR); Hong Sun LEE, Yongin-si (KR)

(21) Appl. No.: 18/894,760

(22) Filed: Sep. 24, 2024

(30) Foreign Application Priority Data
Aug. 20, 2024 (KR) 10-2024-0111112

(51) Int. Cl. H01G 4/12; H01G 4/30

(52) U.S. Cl. CPC H01G 4/129; H01G 4/30

(57) ABSTRACT

Provided are a dielectric powder composition for multilayer ceramic capacitors. The dielectric powder composition includes 93 to 98.5 wt % of a main ingredient composed of dielectric base material powder, 1.0 to 5.0 wt % of a first sub-ingredient including glass powder coated on an outer periphery of the dielectric base material powder to form a core-shell structure, and 0.5 to 2.0 wt % of a second sub-ingredient made of a transition metal oxide mixed with the core-shell structure powder, wherein the main ingredient is non-stoichiometrically represented as [(BaₓCa_{y}Sr_{1-x-y})O]ₘ[(Ti_{z}Zr_{1-z})O₂](where x: 0.22 to 0.42, y: 0.10 to 0.35, z: 0.03 to 0.08, and m ranges from 0.85 to 1.05), the first sub-ingredient includes an alkaline earth metal compound including (Ba, Sr, Ca), SnO₂, B₂O₃ and SiO₂, and the second sub-ingredient includes at least two selected from the group consisting of manganese oxide (Mn₃O₄), tungsten oxide (WO₃), and aluminum oxide (Al₂O₃).

### TECHNICAL FIELD

The present invention relates to a dielectric powder composition for multilayer ceramic capacitors and a manufacturing method thereof, and especially to a class I dielectric powder composition with high insulation resistance and excellent withstand voltage properties per unit thickness, and a manufacturing method thereof.

### BACKGROUND ART

A multilayer ceramic capacitor (MLCC) may serve as bypass, decoupling/coupling, charge storage, filtering, different frequency discrimination and circuit tuning in an electronic circuit.

In addition, the MLCC may partially replace an organic film capacitor and an electrolytic capacitor of a high-frequency switching power supply, a computer network power supply, and a mobile communication device, and greatly improve filtering performance and interference prevention performance of the high-frequency switching power supply.

Recently, demand for miniaturization, high-capacity, high-pressure, and high-reliability is increasing in a multilayer ceramic capacitor (MLCC) according to the electrification of a vehicle and an electric power vehicle such as a hybrid electric vehicle or an electric vehicle (xEV). In particular, in a power conversion system according to xEV, there is a rapid increase in the demand of class I MLCCs with high temperature stability and excellent loss characteristics as the adoption of an inductor-inductor-capacitor (LLC) resonant converter increases.

According to the Electronic Industries Association (EIA) specification, MLCCs are largely divided into class I and class II, and class I MLCCs employ dielectrics called “dielectrics for temperature compensation” because there is little change in dielectric constant due to temperature changes such as COG and U2J, and paraelectrics such as (Ca, Sr) (Ti, Zr)O₃ are used.

The capacitance change rate (AC) according to the temperature of COG_(NPO), which represents the capacity temperature characteristic of the EIA specification, is 0±30 ppm/° C., which means less than ±0.3% difference at −55° C. to +125° C., and the capacitance change rate (ΔC) according to the temperature of the U2J characteristics satisfy −750±120 ppm/° C., for example.

Class II MLCCs are high dielectric constant ceramic capacitors. Ferroelectric materials such as BaTiO₃ and (Ba, Ca)(Ti, Zr)O₃ are used as dielectric materials. High dielectric (high-k) MLCC specifications are represented in three-digit codes, such as Y5V, X5R, and X7R, with the first and second digit codes representing the minimum and maximum temperatures guaranteed, respectively, and the third code representing the allowable limit of the rate of change in capacitance within the warranty temperature range.

Currently, MgTiO₃, CaTiO₃—SrTiO₃, and BaO—Nd₂O₃—TiO₂ dielectrics are mostly used in class I MLCCs, but there is a problem of having to use expensive Pd or Ag—Pd as a conductor for the internal electrode layer. Meanwhile, when Cu or Ni metal is used as an internal electrode, the composition of (CaSr)(ZrTi)O₃ is mostly applied as a CaZrO₃ system having reduction-resistance.

When a dielectric having a class I composition having a reduction-resistance is applied, a thin layer design of a dielectric layer is required for a high-capacity multilayer ceramic capacitor (MLCC) because a dielectric constant is low to 28 to 32, and accordingly, a problem of deterioration in withstand voltage characteristics is generated, and thus it is difficult to implement a large capacity and high voltage characteristic as a capacitor for an x-EV power conversion circuit. Therefore, there is a need for a dielectric ceramic composition that can be sintered in a reduction-resistant atmosphere and has high dielectric constant and excellent withstand voltage characteristics.

### SUMMARY OF THE INVENTION

### Technical Problem

Accordingly, it is an objective of the present invention to provide a dielectric powder composition for a multilayer ceramic capacitor (MLCC) and a manufacturing method thereof, which is capable of being prepared into class I dielectric powder having high insulation resistance and excellent withstand voltage characteristics per unit thickness by preparing non-stoichiometric dielectric starting powder and then mixing a glass powder composition for matching a stoichiometric composition with the non-stoichiometric dielectric starting powder, and performing heat-treatment of the mixture.

It is another objective of the present invention to provide a dielectric powder composition for a multilayer ceramic capacitor (MLCC), and a manufacturing method thereof, which is configured by calcining a main composition (base material) to be synthesized into a non-stoichiometric composition, adding glass powder to the synthesized result to improve stoichiometric composition and dielectric properties to obtain heat-treated dielectric ceramic powder, and adding transition metal powder to the heat-treated dielectric ceramic powder to improve insulation resistance at a high temperature.

It is still another objective of the present invention to provide a dielectric powder composition for a multilayer ceramic capacitor (MLCC) and a manufacturing method thereof, which may prevent rapid expansion and degradation of insulation resistance caused by carbon generated during sintering by forming a core-shell shape by coating glass ingredients on non-stoichiometric main composition (base material) powder by mixing glass powder with non-stoichiometric dielectric starting powder and then rapidly heat-treating the mixture using a roller hearth kiln (RHK) electric furnace during heat-treatment.

It is a yet another object of the present invention to provide a dielectric powder composition for high-capacity and high-voltage multilayer ceramic capacitor (MLCC) for class I reduction-resistance having a relatively high dielectric constant of 38 to 45 and high temperature insulation resistance and excellent insulation breakdown voltage (BDV) characteristics while having a high quality factor and excellent dielectric constant temperature stability (COG characteristics).

### Technical Solution

According to an aspect of the present invention, there is provided a dielectric powder composition for a multilayer ceramic capacitor (MLCC), the electric powder composition including 93 to 98.5 wt % of a main ingredient composed of dielectric base material powder, 1.0 to 5.0 wt % of a first sub-ingredient including glass powder coated on an outer periphery of the dielectric base material powder to form a core-shell structure, and 0.5 to 2.0 wt % of a second sub-ingredient made of a transition metal oxide mixed with the core-shell structure powder, wherein the main ingredient may be non-stoichiometrically represented as [(BaₓCa_{y}Sr_{1-x-y}) O]ₘ[(Ti_{z}Zr_{1-z})O₂](where x ranges from 0.22 to 0.42, y ranges from 0.10 to 0.35, z ranges from 0.03 to 0.08, and m ranges from 0.85 to 1.05), the first sub-ingredient may include an alkaline earth metal compound including (Ba, Sr, Ca), SnO₂, B₂O₃ and SiO₂, and the second sub-ingredient may include at least two selected from the group consisting of manganese oxide (Mn₃O₄), tungsten oxide (WO₃), and aluminum oxide (Al₂O₃).

The first sub-ingredient may include 38 to 57 wt % of an alkaline earth metal compound including (Ba, Sr, Ca), 41.7 to 60.6 wt % of SiO₂, 0.3 to 1.0 wt % of SnO₂, and 0.1 to 0.3 wt % of B₂O₃.

In this case, the Ba compound may be one of BaO, BaCO₃, and BaF₂, the Ca compound may be one of CaO, CaCO₃, and CaF₂, and the Sr compound may be one of SrO, SrCO₃, and SrF₂.

The dielectric powder composition may have a dielectric constant of 38 to 45, a particle size (D₅₀) of 100 to 300 nm, a quality factor of 1000 or less, and insulation resistance of 1000 G-ohm or more. The class I capacity temperature characteristic (TCC) may satisfy a capacitance change rate (ΔC) of 0±30 ppm/° C. according to the temperature of COG.

According to another aspect of the present invention, there is provided a method of manufacturing a dielectric powder composition for multilayer ceramic capacitors (MLCC), the method including preparing non-stoichiometric dielectric starting powder using a solid state method, preparing glass powder to match a stoichiometric composition to the non-stoichiometric dielectric starting powder, mixing the non-stoichiometric dielectric starting powder with the glass powder, followed by heat-treatment through rapid heating to coat the outer periphery of the non-stoichiometric dielectric starting powder with a glass frit to form core-shell structure dielectric powder, and adding transition metal oxide powder to the core-shell structure dielectric powder to prepare a dielectric powder composition, wherein the dielectric powder composition includes 93 to 98.5 wt % of a main ingredient including the non-stoichiometric dielectric starting powder, 1.0 to 5.0 wt % of a first sub-ingredient including the glass powder, and 0.5 to 2.0 wt % of a second sub-ingredient including the transition metal oxide, the main ingredient may be non-stoichiometrically represented as [(BaₓCa_{y}Sr_{1-x-y})O]ₘ[(Ti_{z}Zr_{1-z})O₂](where x ranges from 0.22 to 0.42, y ranges from 0.10 to 0.35, z ranges from 0.03 to 0.08, and m ranges from 0.85 to 1.05), the first sub-ingredient may include an alkaline earth metal compound including (Ba, Sr, Ca), SnO₂, B₂O₃ and SiO₂, and the second sub-ingredient may include at least two selected from the group consisting of manganese oxide (Mn₃O₄), tungsten oxide (WO₃), and aluminum oxide (Al₂O₃).

According to the present invention, a stoichiometric dielectric powder composition in the form of a core-shell may be obtained according to the manufacturing method.

The non-stoichiometric dielectric starting powder is prepared by mixing BaCO₃, CaCO₃, SrCO₃, TiO₂, and ZrO₂ as the non-stoichiometric dielectric starting raw materials, dispersing the mixture, and calcining and grinding the obtained dielectric starting raw materials, where The temperature condition of the calcination may be set to 1020 to 1080° C. for 2 to 4 hours, and the size (D₅₀) of the dielectric starting powder may be set to 100 to 300 nm.

In addition, in the preparing of glass powder to match a stoichiometric composition to the non-stoichiometric dielectric starting powder, the glass powder is prepared by quenching and pulverizing soluble glass (waterglass) obtained by mixing and melting the glass powder composition containing 38 to 57 wt % of an alkaline earth metal compound including (Ba, Sr, Ca), 41.7 to 60.6 wt % of SiO₂, 0.3 to 1.0 wt % of SnO₂, and 0.1 to 0.3 wt % of B₂O₃, where the glass powder may have a particle size D₅₀ of about 80 nm to about 300 nm and a specific surface area BET of about 8 m²/g to about 15 m²/g.

Furthermore, in the mixing of the non-stoichiometric dielectric starting powder with the glass powder, followed by heat-treatment through rapid heating to coat the outer periphery of the non-stoichiometric dielectric starting powder with a glass frit to form core-shell structure dielectric powder, The heat-treatment through rapid heating uses a roller hearth kiln (RHK) electric furnace, and the temperature condition for the rapid heating heat-treatment may be heated at 50 to 100° C./min and then heat-treated at 700 to 1000° C.

### BRIEF DESCRIPTION OF THE DRAWINGS

FIG. 1 is a flowchart illustrating a method of manufacturing a multilayer ceramic capacitor (MLCC) by using a dielectric powder composition for a MLCC according to a preferred embodiment of the present invention.

FIG. 2 is a conceptual diagram illustrating a structure of dielectric powder having a core-shell structure according to mixing of a first ingredient and a second ingredient when preparing a dielectric powder composition for a MLCC according to the present invention.

FIG. 3 is a cross-sectional view of a MLCC manufactured by using a dielectric powder composition for a MLCC according to a preferred embodiment of the present invention.

### DETAILED DESCRIPTION OF THE INVENTION

Hereinafter, embodiments of the present invention will be described in detail with reference to the accompanying drawings.

The sizes and shapes of the ingredients shown in the drawings may be exaggerated for clarity and convenience. In addition, terms defined in consideration of the configuration and operation of the present invention may vary depending on the intention or custom of the user, the operator, and the like. Definitions of these terms should be based on the content of this specification.

Hereinafter, a dielectric powder composition for a multilayer ceramic capacitor (MLCC) according to embodiments of the present invention and a manufacturing method thereof will be described with reference to the accompanying drawings as follows.

### Dielectric Powder Composition

A dielectric powder composition for multilayer ceramic capacitors (MLCC), according to an embodiment of the present invention, includes: 93 to 98.5 wt % of a main ingredient (such as dielectric base material powder); 1.0 to 5.0 wt % of a first sub-ingredient (glass powder) coated on an outer periphery of the dielectric base material powder to form a core-shell structure; and 0.5 to 2.0 wt % of a second sub-ingredient (transition metal oxide) mixed with the core-shell structure powder.

The main ingredient (dielectric base material powder) may be non-stoichiometrically represented as [(BaₓCa_{y}Sr_{1-x-y})O]ₘ[(Ti_{z}Zr_{1-z})O₂](where x ranges from 0.22 to 0.42, y ranges from 0.10 to 0.35, z ranges from 0.03 to 0.08, and m ranges from 0.85 to 1.05), and the size D₅₀ of the powder may be set to 100 to 300 nm.

The main ingredient (dielectric base material powder) may be prepared into a non-stoichiometric dielectric base material using a solid state method. In this case, BaCO₃, CaCO₃, SrCO₃, TiO₂, and ZrO₂ may be used as starting raw materials for the dielectric base materials, and the starting raw materials of the dielectric base materials may be mixed and dispersed by a general solid state method (S11).

Thereafter, the starting raw material of the mixed and dispersed dielectric base material is calcined and pulverized, and the temperature conditions of the calcination may be set to 1020 to 1080° C. and 2 to 4 hours in consideration of the phase formation, the crystallinity, the residual carbon content, the particle size distribution of the powder during pulverization, and the specific surface area (BET) of the powder (S12).

The starting material of the dielectric base material is not limited to only the oxide, and the size (D₅₀) of the dielectric base material powder may be set to 100 to 300 nm after calcination and grinding.

The alkaline earth metal compound including (Ba, Sr, Ca) as the first sub-ingredient (glass powder) improves solubility and dielectric properties during the formation of glass, but the content thereof should be limited to 38 wt % to 57 wt %. The reason is that these ingredients are not incorporated into the crystal phase, but if they are less than 38 wt %, the dielectric constant characteristics are deteriorated, and if they exceed 57 wt %, the crystallization action is adversely affected during conversion to glass frit.

Preferably, the first sub-ingredient may include 38 to 57 wt % of an alkaline earth metal compound including (Ba, Sr, Ca), 41.7 to 60.6 wt % of SiO₂, 0.3 to 1.0 wt % of SnO₂, and 0.1 to 0.3 wt % of B₂O₃.

SnO₂ serves as a mixed nucleation agent in glass formation, and thus, is mixed with other ingredients, thereby serving to suppress the phase separation phenomenon of glass and stabilize the electrical properties of the dielectric when fired together with ceramic powder.

B₂O₃ has the effect of lowering the softening temperature (Ts) and the coefficient of thermal expansion (CTE), has the property of imparting fluidity when manufacturing glass powder, and has the property of reacting with water, and thus, B₂O₃ should not exceed 0.3 wt %.

The first sub-ingredient composition is a glass powder with a network structure and should satisfy the conditions of long-term stability against changes in chemical stability, mechanical strength, and dielectric properties (e.g., dielectric constant, temperature coefficient of capacitance (TCC), and insulation resistance enhancement).

In consideration of this, in this invention, when the first sub-ingredient (glass powder) is included in and mixed with the main ingredient (dielectric base material powder) in the range of 1.0 to 5.0 wt %, and then rapid heat-treatment is performed for the resultant, a glass ingredient, which is a first sub-ingredient, is coated on the dielectric starting powder, which is a non-stoichiometric main ingredient, to form a core-shell composite structure, thereby preventing rapid expansion and a decrease in insulation resistance due to carbon generated during sintering.

When manufacturing the glass powder of the first sub-ingredient, the Ba compound may be one of BaO, BaCO₃, and BaF₂, the Ca compound may be one of CaO, CaCO₃, and CaF₂, the Sr compound may be one of SrO, SrCO₃, and SrF₂, and Sn and Si may be applied with SnO₂ and SiO₂, respectively.

The glass powder is prepared by introducing and mixing the ceramic glass powder composition having the composition of Table 1 shown in FIG. 4 (S13), and then melting the mixture at 1450 to 1600° C. using a platinum crucible to prepare a soluble glass (waterglass). Subsequently, the glass flakes may be prepared by quenching the soluble glass (waterglass), and then dry-milled to prepare glass powder (glass frit) (S14).

In this case, the glass powder may preferably have a particle size D₅₀ of 80 nm to 300 nm and a specific surface area BET of 8 m²/g to 15 m²/g.

The second sub-ingredient (transition metal oxide) is a transition metal oxide used as an additive and includes at least two selected from the group consisting of manganese oxide (Mn₃O₄), tungsten oxide (WO₃), and aluminum oxide (Al₂O₃) (S17). Manganese oxide (Mn₃O₄), tungsten oxide (WO₃), and aluminum oxide (Al₂O₃) each act as acceptors and absorb free electrons generated by sintering in a reducing atmosphere to improve the quality factor (Q) value and enhance reduction resistance.

### Method of Preparing Dielectric Powder Composition

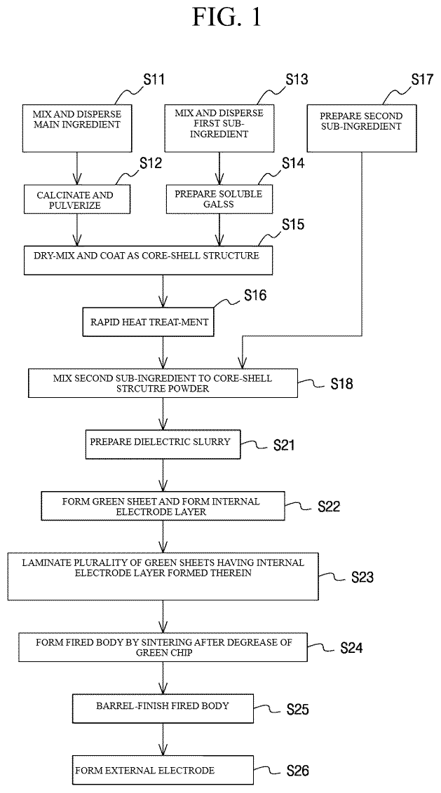

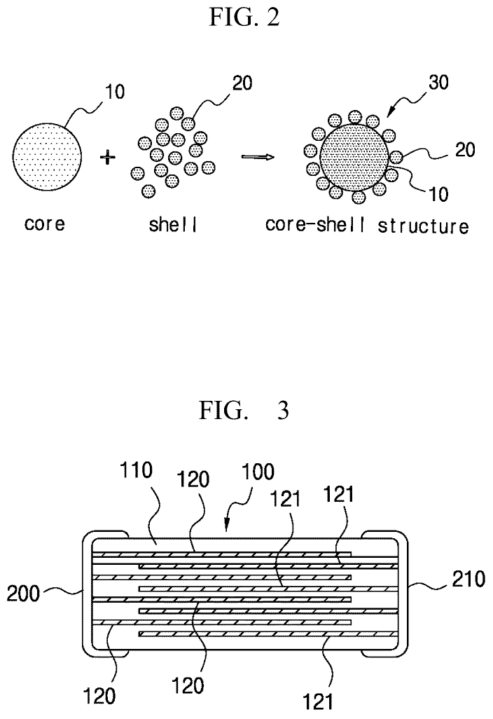

FIG. 1 is a flowchart illustrating a method of manufacturing a multilayer ceramic capacitor (MLCC) by using a dielectric powder composition for a MLCC according to a preferred embodiment of the present invention, and FIG. 2 is a conceptual diagram illustrating a structure of dielectric powder having a core-shell structure according to a mixture of a main ingredient and a first sub-ingredient when preparing a dielectric powder composition according to the present invention.

Referring to FIG. 1, a method of manufacturing a dielectric powder composition for multilayer ceramic capacitors (MLCC), according to another aspect of the present invention, includes: preparing non-stoichiometric dielectric starting powder (main ingredient) using a solid state method (S11 and S12); preparing glass powder (first sub-ingredient) required for the composition of a stoichiometric dielectric powder (S13 and S14); dry mixing the non-stoichiometric dielectric starting powder with the glass powder required for the stoichiometric composition to form dielectric powder 30 of a core-shell structure in which a glass ingredient is coated on the non-stoichiometric dielectric starting powder (main ingredient; core) 10 (S15); rapidly heating and heat-treating the core-shell structure dielectric powder 30 for interfacial adhesion and stoichiometric stabilization between the core 10 and the shell 20 (S16); and preparing a final dielectric powder composition by mixing and dispersing a transition metal oxide (a second sub-ingredient) into the heat-treated core-shell structure dielectric powder 30 (S17 and S18).

The preparing of the non-stoichiometric dielectric starting powder (main ingredient; core) 10 steps (S11 and S12) and the preparing of the glass powder (first sub-ingredient) 20 required for the formation of the stoichiometric dielectric powder composition are (S13 and S14) may be confirmed through the description of the dielectric powder composition described above.

In this case, when preparing a non-stoichiometric dielectric starting powder (main ingredient; core) using the solid state method in the steps (S11 and S12), the non-stoichiometric dielectric starting powder (main ingredient; core) 10 is mixed and dispersed with the dielectric starting raw material having the composition of Table 2 below, and then, in the calcination process, calcination is performed at 1020 to 1080° C. (e.g., 1050° C.) for 2 to 4 hours to produce highly crystalline dielectric starting powder while lowering the heat-treatment temperature, and then the dielectric starting powder with a particle size (D₅₀) of 100 to 300 nm may be obtained through pulverization of the dielectric starting raw material.

Each of the starting raw materials of the dielectric base material may form an additional form such as an oxide or carbonate.

In addition, in operation S15, the non-stoichiometric dielectric starting powder (main ingredient; core) 10 may be dry-mixed with the glass powder (first sub-ingredient) 20 required for stoichiometric composition using a revolution rotation shaking mixer or a double shaking mixer.

Moreover, in order to stabilize the interfacial adhesion and stoichiometric stabilization between the core and the shell in operation S16, the heat-treatment through rapid heating for the dielectric powder 30 of the core-shell structure may be performed using a roller heart kiln (RHK) electric furnace.

A temperature condition for the rapid heating heat-treatment is increased to 50 to 100° C./min, and then the heat-treatment is performed at 700 to 1000° C.

The formation of the core-shell structure dielectric powder 30 may prevent rapid expansion and a decrease in insulation resistance due to carbon (C) generated during sintering when carbonate is used instead of oxide as a starting raw material for the dielectric starting powder (main ingredient; core).

In operations S17 and S18, a transition metal oxide (second sub-ingredient) is prepared, and then the prepared transition metal oxide (second sub-ingredient) is mixed and dispersed with the core-shell structure dielectric powder 30 that has been thermal-treated, to prepare a final dielectric powder composition.

The particle size (D₅₀) of the final dielectric powder according to the present invention obtained through operations S17 and S18 is set in the range of 100 to 300 nm.

The dielectric powder composition for a multilayer ceramic capacitor (MLCC) according to this invention may improve the dielectric constant due to a high capacity and prevent reliability degradation due to a decrease in the dielectric thickness.

After manufacturing a green sheet using the final dielectric powder composition obtained through the manufacturing process, the multilayer ceramic capacitor (MLCC) 100 shown in FIG. 3 may be obtained by using the green sheet.

First, ethanol/toluene is added as a solvent to the final dielectric powder composition where a transition metal oxide (second sub-ingredient) is mixed and dispersed with the heat-treated core-shell structure powder 30. Then, after mixing and dispersing the resultant using a wet grinder such as a basket mill or an apex mill machine, a dielectric slurry is prepared by adding a polyvinyl butyral (PVB), a dispersant, or the like to the mixed and dispersed resultant (S21).

The resulting dielectric slurry is then subjected to a doctor blade method or slot-die coating to produce a green sheet. When the green sheet is formed, an electrode material paste is printed on the surface of the green sheet by a screen printing method to form first and second internal electrode layers 120 and 121 (S22).

The first and second internal electrode layers 120 and 121 includes, for example, a paste using Ni metal, and the Ni internal electrode paste is formed by mixing nickel (Ni) powder, a binder, a dispersant, and an organic solvent. Here, ethyl cellulose may be used as the binder, glycerol-alpha-monooleate may be used as the dispersant, and terpineol may be used as the organic solvent.

A multilayer ceramic capacitor laminate is manufactured by stacking a plurality of green sheets on which the first and second internal electrode layers 120 and 121 are formed, and then when the multilayer ceramic capacitor laminate is formed, the laminate is compressed to form a compression body. When the pressed body is formed, a multilayer ceramic capacitor green chip is manufactured through a cutting process (S23).

Thereafter, the obtained multilayer ceramic capacitor green chip is degreased to remove the binder, and then the multilayer ceramic capacitor green chip on which the binder has been degreased is sintered in a reducing atmosphere of 1260 to 1340° C. to form a fired body (S24).

When the fired body is formed, the sintered fired body is oxidized to 800 to 1000° C., and when the oxidation treatment is completed, the fired chip 110 is barrel-finished to expose the ends of one side or the other side of the first and second internal electrode layers 120 and 121 in the longitudinal direction (S25).

When the barrel-finishing is completed, the first and second external electrodes 200 and 210 are formed at the ends of one side or the other side of the fired chip 110 in the longitudinal direction to be connected to the first and second internal electrodes formed by the first and second internal electrodes 120 and 121, respectively, and then heat-treated at 600 to 700° C. (S26). Here, nickel (Ni) or copper (Cu) may be used as a material for the first and second external electrodes 200 and 210.

Hereinafter, the present invention will be described in more detail through embodiments and comparative examples, but this is to help a specific understanding of the present invention, and the scope of the present invention is not limited by the embodiments. [0065](Example)

In this embodiment, by using the dielectric powder composition obtained according to the preparation process (S11 to S18) of the dielectric powder composition according to the present invention of FIG. 1, the multilayer ceramic capacitor (MLCC) was prepared according to the preparation process (S21 to S26) of the conventional multilayer ceramic capacitor (MLCC).

To confirm the manufacturing state of the dielectric powder composition with class I characteristics produced according to the manufacturing process (S11 to S18), a multilayer ceramic capacitor (MLCC) with a size of 3216 and a thickness of the dielectric green sheet of 10 μm, and a stack of 50 layers was manufactured using the composition shown in Table 2.

Table 1 shows the composition (A to H) of the glass powder applied to the present invention, Table 2 shows the composition table of the experimental examples (Examples and Comparative Examples), and Table 3 shows the characteristics of the multilayer ceramic capacitor (MLCC) chip manufactured according to the composition specified in Table 2. The sample to which the * mark is added in Table 2 shows a comparative example outside the range of the dielectric powder composition of the present invention.

For each of the multilayer ceramic capacitors (MLCC) manufactured according to the embodiments described above, characteristics tests of capacitance [μF], quality factor (Q Factor), insulation resistance (IR), temperature characteristics of capacitance (TCC), and an accelerated moisture-resistance voltage application test such as a pressure cooker bias test (PCBT) were carried out, and the results are shown in Table 3.

Specifically, the method of measuring dielectric constant and quality factor (Q factor) was measured using an inductance-capacitance-resistance (LCR) meter by applying 1 MHz of alternating current (ΔC) 1 V at room temperature, and the insulation resistance (IR) was measured after applying an electric field strength of 10.5 V/um to a multilayer ceramic capacitor for 60 seconds.

Temperature characteristics of capacitance (TCC), that is, the change in capacity according to temperature, was measured using an LCR meter by applying 1 MHz of AC 1 V while the temperature was changed from −5 5° C. to 125° C.

The characteristic test of the PCBT was tested by applying an electric field strength of 10.5 mA/um to a sample for 30 hours at a temperature of 121° C., 2 atm (atmospheric pressure), 85% of relative humidity (RH). After testing 200 samples, the number of chips peeled between the internal electrode and the dielectric ceramic was measured using an ultrasonic detection test (of 85 MHz), and the multilayer ceramic capacitor to which the composition with defective samples was applied was determined as defective (Bad).

In addition, the insulation resistance (IR) was measured after the accelerated moisture resistance voltage application test (such as PCBT), and if it was less than 1000 [GQ], it was determined as defective (Bad).

TABLE 1

| Glass powder | Alkaline earth metal | | | | | |
|---|---|---|---|---|---|---|
| Composition | compound (wt %) | | | SiO₂ | SnO₂ | B₂O₃ |
| No. | Ba—Ca—Sr | | | (wt %) | (wt %) | (wt %) |
| A | 9 | 3 | 27 | 60.6 | 0.3 | 0.1 |
| B | 10 | 5 | 30 | 53.7 | 1 | 0.3 |
| C | 12 | 8 | 30 | 48.9 | 1 | 0.1 |
| D | 14 | 10 | 29 | 46.2 | 0.5 | 0.3 |
| E | 15 | 12 | 28 | 44.6 | 0.3 | 0.1 |
| F | 15 | 13 | 29 | 42.2 | 0.5 | 0.3 |
| G | 15 | 14 | 28 | 41.9 | 1 | 0.1 |
| H | 16 | 17 | 24 | 41.7 | 1 | 0.3 |

TABLE 2

| | Main ingredient (base material) | | | | | | First sub- | | Second sub- | | |
|---|---|---|---|---|---|---|---|---|---|---|---|
| | [(BaₓCa_{y}Sr_{1-x-y})O]ₘ[(Ti_{z}Zr_{1-z})O₂] | | | | | | ingredient | | ingredient | | |
| | BaO | CaO | SrO | | TiO₂ | ZrO₂ | Glass powder | | Mn₃O₄ | Al₂O₃ | WO₃ |
| Sample | x | y | 1-x-y | m | z | 1-z | Name | wt % | wt % | wt % | wt % |
| 1* | 0 | 0.7 | 0.3 | 1 | 0.05 | 0.95 | A | 1 | 0.3 | 0.25 | 0 |
| 2* | 0.3 | 0 | 0.7 | 1 | 0.03 | 0.97 | A | 1 | 0.3 | 0.25 | 0 |
| 3* | 0 | 0.6 | 0.4 | 1 | 0.05 | 0.95 | A | 1 | 0.3 | 0.25 | 0 |
| 4* | 0 | 0.8 | 0.2 | 1 | 0 | 1 | A | 1 | 0.3 | 0.25 | 0.3 |
| 5* | 0.22 | 0.05 | 0.73 | 0.80 | 0.03 | 0.97 | A | 5 | 0.5 | 0.25 | 0 |
| 6 | 0.22 | 0.10 | 0.68 | 0.85 | 0.05 | 0.95 | A | 3 | 0.3 | 0.25 | 0.1 |
| 7* | 0.22 | 0.10 | 0.68 | 0.90 | 0.09 | 0.91 | A | 1 | 0.3 | 0.1 | 0.1 |
| 8* | 0.26 | 0.10 | 0.64 | 1.20 | 0.05 | 0.95 | B | 0.5 | 0.3 | 0.25 | 0.1 |
| 9 | 0.26 | 0.16 | 0.58 | 0.90 | 0.07 | 0.93 | B | 2 | 0.5 | 0.1 | 0.3 |
| 10 | 0.26 | 0.16 | 0.58 | 0.95 | 0.06 | 0.94 | B | 2 | 0.3 | 0.25 | 0.1 |
| 11* | 0.29 | 0.16 | 0.55 | 0.85 | 0.03 | 0.97 | C | 5 | 0.3 | 0.1 | 0.1 |
| 12 | 0.29 | 0.25 | 0.46 | 0.95 | 0.05 | 0.95 | C | 3 | 0.3 | 0.25 | 0.1 |
| 13* | 0.29 | 0.25 | 0.46 | 1.00 | 0.1 | 0.9 | C | 1 | 0.3 | 0.1 | 0.25 |
| 14* | 0.29 | 0.25 | 0.46 | 1.05 | 0.15 | 0.85 | C | 0.5 | 0.05 | 0.5 | 0.1 |
| 15 | 0.32 | 0.31 | 0.37 | 0.98 | 0.08 | 0.92 | D | 1.5 | 0.3 | 0.1 | 0.1 |
| 16 | 0.32 | 0.31 | 0.37 | 0.95 | 0.07 | 0.93 | D | 2.5 | 0.3 | 0.1 | 0.5 |
| 17* | 0.32 | 0.31 | 0.37 | 1.05 | 0.05 | 0.95 | D | 0.5 | 0.5 | 0.1 | 0.1 |
| 18 | 0.32 | 0.32 | 0.36 | 0.95 | 0.05 | 0.95 | D | 2.5 | 0.5 | 0.25 | 0.25 |
| 19 | 0.32 | 0.32 | 0.37 | 0.90 | 0.03 | 0.97 | D | 3 | 0.3 | 0.25 | 0.1 |
| 20* | 0.35 | 0.32 | 0.33 | 1.00 | 0.15 | 0.85 | E | 1 | 0.5 | 0.25 | 0.25 |
| 21 | 0.35 | 0.35 | 0.3 | 0.85 | 0.07 | 0.93 | E | 3 | 0.3 | 0.25 | 0.1 |
| 22 | 0.35 | 0.35 | 0.3 | 0.90 | 0.05 | 0.95 | E | 1 | 1 | 0.25 | 0.25 |
| 23* | 0.35 | 0.35 | 0.3 | 1.00 | 0.05 | 0.95 | G | 2 | 0.3 | 0.1 | 0.1 |
| 24 | 0.35 | 0.35 | 0.3 | 0.95 | 0.05 | 0.95 | G | 3 | 0.3 | 0.1 | 0.1 |
| 25* | 0.35 | 0.35 | 0.3 | 1.25 | 0.15 | 0.85 | G | 0.5 | 0.5 | 0.5 | 0.1 |
| 26 | 0.42 | 0.30 | 0.28 | 0.85 | 0.03 | 0.97 | G | 5 | 0.3 | 0.1 | 0.3 |
| 27 | 0.42 | 0.30 | 0.28 | 0.95 | 0.03 | 0.97 | G | 3 | 0.5 | 0.1 | 0.3 |
| 28* | 0.42 | 0.30 | 0.28 | 1.00 | 0.03 | 0.97 | G | 1 | 1 | 0.5 | 0.5 |

TABLE 3

| | Electrical characteristics | | | | |
|---|---|---|---|---|---|
| | | | Insulation | Temperature | PCBT |
| | | Quality | resistance | characteristics | Good |
| Sample | Permittivity | factor | G-Ohm | ppm/° C. | Bad |
| 1* | 32 | 2600 | 2000 | 24 | Good |
| 2* | 38 | 2000 | 1200 | 38 | Good |
| 3* | 35.7 | 1800 | 1500 | −28 | Good |
| 4* | 31 | 2500 | 1000 | 67 | Bad |
| 5* | 40.8 | 800 | 850 | 24 | Bad |
| 6 | 41.4 | 1950 | 1680 | 18 | Good |
| 7* | 42 | 2160 | 1890 | 85 | Good |
| 8* | 43.1 | 560 | 85 | 28 | Bad |
| 9 | 42.4 | 1870 | 2500 | 28 | Good |
| 10 | 42.2 | 2450 | 1290 | 28 | Good |
| 11* | 39.8 | 1560 | 1150 | 19 | Good |
| 12 | 41.9 | 1960 | 1890 | 28 | Good |
| 13* | 47 | 350 | 2500 | 120 | Bad |
| 14* | 51 | 211 | 1690 | 180 | Bad |
| 15 | 42.8 | 2100 | 1200 | 18 | Good |
| 16 | 42.1 | 1980 | 1500 | 28 | Good |
| 17* | 42.8 | 162 | 808 | 39 | Bad |
| 18 | 42 | 1680 | 2890 | 28 | Good |
| 19 | 41.3 | 2250 | 2000 | 19 | Good |
| 20* | 51 | 198 | 105 | 186 | Bad |
| 21 | 41.5 | 1290 | 1560 | 18 | Good |
| 22 | 42.3 | 2100 | 2340 | 25 | Good |
| 23* | 42.1 | 2189 | 2890 | 28 | Bad |
| 24 | 42 | 1780 | 2100 | 27 | Good |
| 25* | 46.6 | 1050 | 1200 | 189 | Good |
| 26 | 42 | 1980 | 2600 | 20 | Good |
| 27 | 40.9 | 1890 | 2100 | 18 | Good |
| 28* | 41.2 | 2120 | 1350 | 26 | Bad |

In Table 2, when BaO is less than 0.22, the dielectric constant is less than 38, and thus is excluded from the scope of the present invention, and the highest BaO content is set to 0.42, in consideration of dielectric loss and quality factor.

CaO was set in the range of 0.10 to 0.35, and when it was less than 0.1 or exceeded 0.35, the dielectric constant and quality factor characteristics required by the present invention could not be obtained.

The TiO₂ content was in the range of 0.03 to 0.08, and the COG temperature characteristic was within 30 ppm/° C. When the TiO₂ content was greater than 0.08, for example, in the case of samples 7, 13, 14, 20, and 25, the COG temperature characteristics could not be implemented.

m is set in the range of 0.85 to 1.05, and when glass powder (first sub-ingredient) is added in the range of 1 wt % to 5 wt % based on the main ingredient, a core-shell-type composition was formed in the main ingredient, and high quality reliability characteristics as a class I multilayer ceramic capacitor (MLCC) were obtained. When m was less than 0.85, the insulation resistance (IR) and quality factor characteristics were deteriorated (e.g., sample 5), and when m was 1, (e.g., samples 20, 23, and 28), the dielectric constant, insulation resistance, and quality factor were satisfied, but when conducting an accelerated moisture-resistance voltage application test such as a pressure cooker bias test (PCBT), interfacial peeling due to the thermal expansion coefficient difference between the internal electrode and the dielectric occurred under the accelerated moisture-resistance load or the insulation resistance (IR) deteriorated, resulting in a defective (Bad) form. When m exceeds 1.05 (e.g., samples 8 and 25), the quality factor and insulation resistance rapidly decreased due to the addition of glass powder (first sub-ingredient), and thus, characteristics as class I multilayer ceramic capacitor (MLCC) could not be obtained.

As described above, according to the present invention, non-stoichiometric dielectric starting powder (base material) is prepared, and then a glass powder (first sub-ingredient) composition for matching a stoichiometric composition is mixed with the non-stoichiometric dielectric starting powder, and heat-treatment of the mixture is performed. Accordingly, a glass ingredient is coated on a dielectric starting powder (base material) to form a core-shell structure to prevent rapid expansion and a decrease in insulation resistance due to carbon generated during sintering, thereby manufacturing a class I dielectric powder with high insulation resistance and high dielectric constant.

As described above, in the present invention, non-stoichiometric dielectric starting powder is prepared, a glass powder composition for matching a stoichiometric composition is mixed with the non-stoichiometric dielectric starting powder, and the mixture is heat-treated, to prepare dielectric powder for a class I multilayer ceramic capacitor (MLCC) with high insulation resistance and excellent withstand voltage characteristics per unit thickness.

In addition, the present invention may provide a dielectric powder composition for a multilayer ceramic capacitor (MLCC), which is configured by calcining a main composition (base material) to be synthesized into a non-stoichiometric composition, adding glass powder to the synthesized result to improve stoichiometric composition and dielectric properties to obtain heat-treated dielectric ceramic powder, and adding transition metal powder to the heat-treated dielectric ceramic powder to improve insulation resistance at a high temperature.

Furthermore, the present invention may provide a dielectric powder composition for a multilayer ceramic capacitor (MLCC), which may prevent rapid expansion and degradation of insulation resistance caused by carbon generated during sintering by forming a core-shell shape by coating glass ingredients on non-stoichiometric main composition (base material) powder by mixing glass powder with non-stoichiometric dielectric starting powder and then rapidly heat-treating the mixture using a roller hearth kiln (RHK) electric furnace during heat-treatment.

In addition, the present invention may provide a dielectric powder composition for high-capacity and high-voltage multilayer ceramic capacitor (MLCC) for class I reduction-resistance having a relatively high dielectric constant of 38 to 45 and high temperature insulation resistance and excellent insulation breakdown voltage (BDV) characteristics while having a high quality factor and excellent dielectric constant temperature stability (COG characteristics).

According to this invention, in the case of dielectric powder with high capacity and high reliability of class I multilayer ceramic capacitor (MLCC), a primary main ingredient is made into non-stoichiometric starting powder by a solid state method, to prepare, during a calcination process, dielectric starting powder with high crystallinity while lowering a heat-treatment temperature, to thus obtain, dielectric starting powder having a particle size (D₅₀) of 100 to 300 nm through pulverization of a raw material calcinated at 1050° C., and to obtain a stoichiometric dielectric powder composition in the form of a core-shell by adding an alkaline earth metal compound including (Ba, Sr, Ca) to a non-stoichiometrically formed main composition and glass powder including SnO₂, B₂O₃ and SiO₂.

As a result, the stoichiometric dielectric powder composition in the form of a core-shell obtained according to the present invention may have a particle size (D₅₀) in the range of 100 to 300 nm, a quality factor of 1000 or less, and insulation resistance of 1000 G-ohm or more.

While the present invention has been particularly shown and described with reference to exemplary embodiments thereof, by way of illustration and example only, it is clearly understood that the present invention is not to be construed as limiting the present invention, and various changes and modifications may be made by those skilled in the art within the protective scope of the invention without departing off the spirit of the present invention.

What is claimed is:

1. A dielectric powder composition comprising:
93 to 98.5 wt % of a main ingredient composed of dielectric base material powder;
1.0 to 5.0 wt % of a first sub-ingredient including glass powder coated on an outer periphery of the dielectric base material powder to form a core-shell structure; and
0.5 to 2.0 wt % of a second sub-ingredient made of a transition metal oxide mixed with the core-shell structure powder, wherein
the main ingredient is non-stoichiometrically represented as [(BaₓCa_{y}Sr_{1-x-y})O]ₘ[(Ti_{z}Zr_{1-z}) O₂](where x ranges from 0.22 to 0.42, y ranges from 0.10 to 0.35, z ranges from 0.03 to 0.08, and m ranges from 0.85 to 1.05),
the first sub-ingredient includes an alkaline earth metal compound including (Ba, Sr, Ca), SnO₂, B₂O₃ and SiO₂, and
the second sub-ingredient includes at least two selected from the group consisting of manganese oxide (Mn₃O₄), tungsten oxide (WO₃), and aluminum oxide (Al₂O₃).

2. The dielectric powder composition of claim 1, wherein the first sub-ingredient includes 38 to 57 wt % of an alkaline earth metal compound including (Ba, Sr, Ca), 41.7 to 60.6 wt % of SiO₂, 0.3 to 1.0 wt % of SnO₂, and 0.1 to 0.3 wt % of B₂O₃.

3. The dielectric powder composition of claim 2, wherein the Ba compound is one of BaO, BaCO₃, and BaF₂, the Ca compound is one of CaO, CaCO₃, and CaF₂, and the Sr compound is one of SrO, SrCO₃, and SrF₂.

4. The dielectric powder composition of claim 1, wherein the dielectric powder composition has a dielectric constant of 38 to 45, a particle size (D₅₀) of 100 to 300 nm, a quality factor of 1000 or less, and insulation resistance of 1000 G-ohm or more, and the class I capacity temperature characteristic (TCC) satisfies a capacitance change rate (ΔC) of 0±30 ppm/° C. according to the temperature of COG.

5. A method of manufacturing a dielectric powder composition for multilayer ceramic capacitors (MLCC), the method comprising:
preparing non-stoichiometric dielectric starting powder using a solid state method;
preparing glass powder to match a stoichiometric composition to the non-stoichiometric dielectric starting powder;
mixing the non-stoichiometric dielectric starting powder with the glass powder, followed by heat-treatment through rapid heating to coat the outer periphery of the non-stoichiometric dielectric starting powder with a glass frit to form core-shell structure dielectric powder; and
adding transition metal oxide powder to the core-shell structure dielectric powder to prepare a dielectric powder composition, wherein
the dielectric powder composition comprises: 93 to 98.5 wt % of a main ingredient including the non-stoichiometric dielectric starting powder; 1.0 to 5.0 wt % of a first sub-ingredient including the glass powder; and 0.5 to 2.0 wt % of a second sub-ingredient including the transition metal oxide, wherein
the main ingredient is non-stoichiometrically represented as [(BaₓCa_{y}Sr_{1-x-y})O]ₘ[(Ti_{z}Zr_{1-z}) O₂](where x ranges from 0.22 to 0.42, y ranges from 0.10 to 0.35, z ranges from 0.03 to 0.08, and m ranges from 0.85 to 1.05),
the first sub-ingredient includes an alkaline earth metal compound including (Ba, Sr, Ca), SnO₂, B₂O₃ and SiO₂, and
the second sub-ingredient includes at least two selected from the group consisting of manganese oxide (Mn₃O₄), tungsten oxide (WO₃), and aluminum oxide (Al₂O₃).

6. The method of manufacturing a dielectric powder composition of claim 5, wherein
the non-stoichiometric dielectric starting powder is prepared by mixing BaCO₃, CaCO₃, SrCO₃, TiO₂, and ZrO₂ as the non-stoichiometric dielectric starting raw materials, dispersing the mixture, and calcining and grinding the obtained dielectric starting raw materials, where
the temperature condition of the calcination is set to 1020 to 1080° C. for 2 to 4 hours, and the size (D₅₀) of the dielectric starting powder is set to 100 to 300 nm.

7. The method of manufacturing a dielectric powder composition of claim 5, wherein, in the preparing of glass powder to match a stoichiometric composition to the non-stoichiometric dielectric starting powder, the glass powder is prepared by quenching and pulverizing soluble glass (waterglass) obtained by mixing and melting the glass powder composition containing 38 to 57 wt % of an alkaline earth metal compound including (Ba, Sr, Ca), 41.7 to 60.6 wt % of SiO₂, 0.3 to 1.0 wt % of SnO₂, and 0.1 to 0.3 wt % of B₂O₃, where
the glass powder has a particle size D₅₀ of 80 nm to 300 nm and a specific surface area BET of 8 m²/g to 15 m²/g.

8. The method of manufacturing a dielectric powder composition of claim 5, wherein, in the mixing of the non-stoichiometric dielectric starting powder with the glass powder, followed by heat-treatment through rapid heating to coat the outer periphery of the non-stoichiometric dielectric starting powder with a glass frit to form core-shell structure dielectric powder, the heat-treatment through rapid heating uses a roller hearth kiln (RHK) electric furnace, and the temperature condition for the rapid heating heat-treatment is heated at 50 to 100° C./min and then heat-treated at 700 to 1000° C.
